(19) United States
(12) Patent Application Publication
(10) Pub. No.: US 2018/0215913 A1
(43) Pub. Date: Aug. 2, 2018

(54) HIGH-TEMPERATURE OIL RESISTANT MOLDED COMPONENT FOR AUTOMOBILE

(71) Applicant: YAZAKI CORPORATION, Tokyo (JP)

(72) Inventor: Hiroshi HIRATA, Shizuoka (JP)

(73) Assignee: YAZAKI CORPORATION, Tokyo (JP)

(21) Appl. No.: 15/884,450

(22) Filed: Jan. 31, 2018

(30) Foreign Application Priority Data
Feb. 1, 2017 (JP) 2017-016524

(51) Int. Cl. C08L 67/02; C08G 63/91

(52) U.S. Cl. CPC C08L 67/02; C08L 2201/08; C08G 63/916

(57) ABSTRACT

A high-temperature oil resistant molded component for an automobile including a resin composition containing a polybutylene terephthalate resin and having a carboxyl end group concentration of 20 mmol/kg or less is provided. The resin composition preferably contains 0.1 to 0.5 parts by mass of an epoxy compound or 0.5 to 5 parts by mass of a carbodiimide compound with respect to 100 parts by mass of the polybutylene terephthalate resin. With such a configuration, the molded component for an automobile is excellent in high-temperature oil resistance.

### CROSS-REFERENCE TO RELATED APPLICATIONS

This application is based upon and claims the benefit of priority from the prior Japanese Patent Application No. 2017-016524, filed on Feb. 1, 2017, the entire contents of which are incorporated herein by reference.

### BACKGROUND OF THE INVENTION

### 1. Field of the Invention

The present invention relates to a molded component for an automobile. More specifically, the present invention relates to a molded component for an automobile, the molded component being produced by molding a resin composition containing a polybutylene terephthalate resin and being excellent in oil resistance at high temperature.

### 2. Description of the Related Art

For vehicles such as automobiles and trucks, molded components used in parts exposed to oil, such as the periphery of an engine and a transmission case for automatic transmission, are required to have oil resistance. Polyamide (PA resin) and polyphenylene sulfide (PPS resin) are frequently used as materials for conventional molded components for an automobile that requires oil resistance (for example, see JP 2014-93176 A).

However, in such conventional materials, PA resin is problematic for application to small components because PA resin has water absorbing properties that degrade the dimensional stability and strength of a molded article. In addition, PPS resin has a problem that mold staining due to gas generated during molding occurs, and a problem that voids are generated in a molded article having a complicated shape. Furthermore, there has been also a problem that it is difficult to form a lance portion for locking and holding a terminal, a lock portion for fitting a connector, and the like for a small component such as a connector by using PPS resin because PPS resin has low flexibility.

Polybutylene terephthalate (PBT resin) is a more manageable material to solve these problems, but there is a problem that PBT resin is inferior to PA resin and PPS resin in oil resistance. Therefore, in order to solve such a problem, for example, in JP 2006-117907 A, a method of compatibilizing PPS resin in PBT resin has been proposed.

Also, in JP 2010-277748 A, it has been proposed to improve oil resistance by adding a large amount of thermoplastic elastomer to PBT resin.

### BRIEF SUMMARY OF THE INVENTION

However, in the technique disclosed in JP 2006-117907 A, since PPS resin is used, there is a problem of gas generation during molding as described above. In addition, in the technique disclosed in JP 2010-277748 A, addition of a large amount of thermoplastic elastomer leads to decrease in mechanical strength, and thus using this technique for a molded component for an automobile (for example, a connector) requiring strength is problematic.

The present invention has been made in view of such problems of conventional techniques. An object of the present invention is to provide a high-temperature oil resistant molded component for an automobile, the molded component being produced by molding a resin composition containing a polybutylene terephthalate resin and having excellent high-temperature oil resistance without causing various problems such as generation of gas during molding and decrease in mechanical strength.

A high-temperature oil resistant molded component for an automobile according to a first aspect of the present invention includes a resin composition containing a polybutylene terephthalate resin and having a carboxyl end group concentration of 20 mmol/kg or less.

A high-temperature oil resistant molded component for an automobile according to a second aspect of the present invention relates to the high-temperature oil resistant molded component for an automobile according to the first aspect, wherein the resin composition contains 0.1 to 0.5 parts by mass of an epoxy compound with respect to 100 parts by mass of the polybutylene terephthalate resin.

A high-temperature oil resistant molded component for an automobile according to a third aspect of the present invention relates to the high-temperature oil resistant molded component for an automobile according to the first aspect, wherein the resin composition contains 0.5 to 5 parts by mass of a carbodiimide compound with respect to 100 parts by mass of the polybutylene terephthalate resin.

A high-temperature oil resistant molded component for an automobile according to a fourth aspect of the present invention relates to the high-temperature oil resistant molded component for an automobile according to the first aspect, wherein the resin composition contains 0.5 to 1 part by mass of a carbodiimide compound with respect to 100 parts by mass of the polybutylene terephthalate resin.

A high-temperature oil resistant molded component for an automobile according to a fifth aspect of the present invention relates to the high-temperature oil resistant molded component for an automobile according to any one of the first to fourth aspects having a flexural modulus of 2600 MPa or more.

A high-temperature oil resistant molded component for an automobile according to a sixth aspect of the present invention relates to the high-temperature oil resistant molded component for an automobile according to any one of the first to fifth aspects, which is a connector or a connector constituting member used for a part that comes into contact with automobile oil.

A method for imparting high-temperature oil resistance to a molded component for an automobile according to a seventh aspect of the present invention includes setting a carboxyl end group concentration of a resin composition containing a polybutylene terephthalate resin to 20 mmol/kg or less.

According to the present invention, a high-temperature oil resistant molded component for an automobile can be provided, the molded component being produced by molding a resin composition containing a polybutylene terephthalate resin and having excellent high-temperature oil resistance without causing various problems such as generation of gas during molding and decrease in mechanical strength.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

A high-temperature oil resistant molded component for an automobile of the present embodiment (hereinafter also referred to as a “molded component for an automobile”) includes a resin composition containing a polybutylene terephthalate resin (PBT resin) and having a carboxyl end group (hereinafter referred to as a “carboxyl end group (CEG)) concentration of 20 mmol/kg or less. The molded component for an automobile of the present embodiment makes it possible to improve the oil resistance of the resin composition without generation of gas or lowering mechanical strength. Specifically, by adjusting the CEG concentration that serves as a decomposition starting point of PBT resin to 20 mmol/kg or less, it becomes possible to improve the oil resistance so that the molded component for an automobile can be used for molded components for an automobile in a part that comes into contact with automobile oil of high temperature. Therefore, the PBT resin composition of the present embodiment can be used even at a part that comes into contact with automobile oil at a high temperature where the conventional PBT resin composition cannot be used, and thus the cost can be reduced.

In the present embodiment, “high-temperature oil resistance” refers to a property with which the retention of bending strength (flexural modulus) after immersion in oil heated to 150° C. or higher for a predetermined time (300 hours) is 90% or more.

First, the resin composition for molding the molded component for an automobile of the present embodiment will be described.

### [PBT Resin]

The PBT resin used for the resin composition of the present embodiment can be produced by polymerizing terephthalic acid and 1,4-butanediol as main raw materials. At that time, another dicarboxylic acid or diol component may be copolymerized therewith according to the purpose.

The dicarboxylic acid component other than terephthalic acid is not particularly limited, and examples thereof include aromatic dicarboxylic acids such as phthalic acid, isophthalic acid, 4,4′-diphenyl dicarboxylic acid, 4,4′-diphenyl ether dicarboxylic acid, 4,4′-diphenoxy ethane dicarboxylic acid, 4,4′-diphenylsulfone dicarboxylic acid, and 2,6-naphthalenedicarboxylic acid, alicyclic dicarboxylic acids such as 1,2-cyclohexanedicarboxylic acid, 1,3-cyclohexanedicarboxylic acid, and 1,4-cyclohexanedicarboxylic acid, and aliphatic dicarboxylic acids such as malonic acid, succinic acid, glutaric acid, adipic acid, and sebacic.

The diol component other than 1,4-butanediol is also not particularly limited, and examples thereof include aliphatic diols ethylene glycol, diethylene glycol, polyethylene glycol, propylene glycol, 1,3-propanediol, polytetramethylene ether glycol, 1,5-pentanediol, neopentyl glycol, 1,6-hexanediol, and 1,8-octanediol, alicyclic diols such as 1,2-cyclohexanediol, 1,4-cyclohexanediol, 1,1-cyclohexanedimethylol, 1,4-cyclohexanedimethylol, and aromatic diols such as xylylene glycol.

The terephthalic acid of the main raw material preferably makes up 80 mol % or more and more preferably 90 mol % or more of the total dicarboxylic acid component. The 1,4-butanediol of the main raw material preferably makes up 85 mol % or more and more preferably 90 mol % or more of the total diol component.

Examples of methods for producing polybutylene terephthalate include a method of undergoing a transesterification reaction of dimethyl terephthalate or the like with 1,4-butanediol, and a method of undergoing a direct esterification reaction of terephthalic acid and 1,4-butanediol. According to the direct esterification reaction using terephthalic acid and 1,4-butanediol as starting materials, polybutylene terephthalate having a high cooling crystallization temperature can be easily obtained as compared with a method involving a transesterification reaction.

Further, by carrying out continuous polymerization, resin of a high quality can be obtained without occurrence of decrease in molecular weight, increase in the amount of carboxyl end group, or increase in the amount of residual tetrahydrofuran caused in accordance with temporal progress of extraction of the product from a reaction vessel after completion of the reaction.

In the present embodiment, the glass fiber is used for improving high-temperature oil resistance and flexural modulus. The average fiber length of the glass fiber is preferably 300 to 550 μm. The average fiber diameter of the glass fiber is preferably 5 to 25 μm.

As the glass fiber described above, glass fiber that is used as a reinforcing material of ordinary PBT and is surface-treated with an organic treating agent such as a silane coupling agent or an epoxy compound may be used. Examples of the silane coupling agent include an aminosilane compound.

In the present embodiment, from the viewpoint of improving high-temperature oil resistance and flexural modulus, the content of the glass fiber is preferably 5 to 25 parts by mass and more preferably 10 to 20 parts by mass with respect to 100 parts by mass of the PBT resin.

### [Epoxy Compound]

In the present embodiment, the epoxy compound has a function of reacting with and blocking a part or all of CEGs, and is used for reducing the CEG concentration of the resin composition. The epoxy compound has at least one epoxy group in the molecule, and examples thereof include a polyfunctional epoxy compound such as a vinyl copolymer including an epoxy resin and a glycidyl group. Further, the epoxy compound may be used alone or in combination of two or more kinds.

Examples of the epoxy resin include glycidyl ether type epoxy resin, glycidyl ester type epoxy resin, glycidyl amine type epoxy resin, heterocyclic epoxy resin, cycloaliphatic epoxy resin, and epoxidized polybutadiene.

Examples of the glycidyl ether type epoxy resin include glycidyl ethers of a polyhydroxy compound [for example, glycidyl ethers of aromatic polyhydroxy compounds such as bisphenol type epoxy resins (e.g., bisphenol A type epoxy resins, bisphenol AD type epoxy resins, and bisphenol F type epoxy resins) and resorcin type epoxy resins; and aliphatic epoxy resins (such as glycidyl ethers of alkylene glycols or polyoxyalkylene glycols)], and novolak type epoxy resins (such as phenol novolak type epoxy resins and cresol novolak type epoxy resins).

Examples of the glycidyl ester type epoxy resin include diglycidyl phthalate, diglycidyl tetrahydrophthalate, diglycidyl hexahydrophthalate, dimethyl glycidyl phthalate, dimethyl glycidyl hexahydrophthalate, dimer acid glycidyl ester, aromatic diglycidyl ester, and cycloaliphatic diglycidyl ester.

Examples of the glycidyl amine type epoxy resin include tetraglycidyl diaminodiphenylmethane, triglycidyl-p-aminophenol, triglycidyl-m-aminophenol, diglycidyl toluidine, tetraglycidyl-m-xylylenediamine, diglycidyl tribromoaniline, and tetraglycidyl bis aminomethyl cyclohexane.

Examples of the heterocyclic epoxy resin include triglycidyl isocyanurate, and hydantoin type epoxy resins.

Examples of the cycloaliphatic epoxy resin include vinyl cyclohexene dioxide, dicyclopentadiene oxide, alicyclic diepoxy acetal, alicyclic diepoxy adipate, and alicyclic diepoxy carboxylate.

Among the epoxy resins described above, a glycidyl ether type epoxy resin or a glycidyl ester type epoxy resin is preferable.

In the present embodiment, from the viewpoint of reducing the CEG concentration of the resin composition and improving the high-temperature oil resistance, the content of the epoxy compound is preferably 0.1 to 0.5 parts by mass and more preferably 0.4 to 0.5 parts by mass with respect to 100 parts by mass of the PBT resin.

### [Carbodiimide Compound]

In the present embodiment, the carbodiimide compound has a function of reacting with and blocking a part or all of CEGs similarly to the epoxy compound, and is used for reducing the CEG concentration of the resin composition. The carbodiimide compound is a compound having at least one carbodiimide group represented by “—N═C═N—” in the molecule. For example, any of an aliphatic carbodiimide compound having an aliphatic main chain, an aromatic carbodiimide compound having an aromatic main chain, and an alicyclic carbodiimide compound having an alicyclic a main chain can be used. In addition, the carbodiimide compound may be used alone or in combination of two or more kinds.

The aliphatic carbodiimide compound and alicyclic carbodiimide compound are compounds having a carbodiimide bond in the molecule (polymer main chain), and can be obtained by reacting an arbitrary aliphatic isocyanate compound or an arbitrary alicyclic isocyanate compound.

Among the carbodiimide compounds described above, aromatic carbodiimide is preferable.

In the present embodiment, from the viewpoint of reducing the CEG concentration of the resin composition and improving the high-temperature oil resistance, the content of the carbodiimide compound is preferably 0.5 to 5 parts by mass and more preferably 4 to 5 parts by mass with respect to 100 parts by mass of the PBT resin.

On the other hand, although the content of the carbodiimide compound is preferably the content described above from the viewpoint of reducing the CEG concentration of the resin composition, contamination of the mold may occur at the time of molding in the case where the content of the carbodiimide compound exceeds 1 part by mass. Therefore, from the viewpoint of reducing the CEG concentration of the resin composition and suppressing the contamination of the mold, the content of the carbodiimide compound is preferably 0.5 to 1 part by mass with respect to 100 parts by mass of the PBT resin.

### [Other Components]

In the present embodiment, the resin composition may contain various additives such as an antioxidant, an ultraviolet absorber, a photodegradation inhibitor, a heat stabilizer, a release agent, a dispersant, a colorant, and a flame retardant.

As has been described, the CEG concentration of the resin composition of the present embodiment is 20 mmol/kg or less, and by setting the CEG concentration to this value, the high-temperature oil resistance can be improved. Conversely, when the CEG concentration of the resin composition exceeds 20 mmol/kg, the high-temperature oil resistance can not be improved. The CEG concentration is preferably 15 mmol/kg or less.

The molded component for an automobile of the present embodiment can be molded by using ordinary molding methods such as injection molding, blow molding, extrusion molding, compression molding, calender molding, and rotational molding using the above resin composition.

Since the molded component for an automobile of this embodiment is excellent in high-temperature oil resistance, the molded component for an automobile of this embodiment is preferably applied to a part that comes into contact with automobile oil at a high temperature in an automobile. Examples of such a component include connectors or components of connectors that come into contact with automobile oil at a high temperature. However, the molded component for an automobile according to the present embodiment is not limited to the examples described above, and may be one of other various electric parts or electronic parts. For example, the molded component for an automobile may be a switch, a capacitor, an integrated circuit, a relay, a resistor, a light emitting diode, a coil bobbin, or a peripheral device thereof.

Examples of the automobile oil that can be brought into contact with the molded component for an automobile of the present embodiment include at least one selected from the group consisting of automatic transmission oil (ATF), continuous variable transmission oil (CVTF), and mission oil (MTF). The mechanical strength such as flexural modulus can be maintained even when the molded component for an automobile of the present embodiment is brought into contact with the automobile oil at a high temperature (for example, 80 to 150° C.). Specifically, the ATF oil is composed mainly of mineral oil (paraffin type or the like) or synthetic oil (ester type, α-olefin type, or the like). In addition, the present invention may be applied to other various automobile oils. For example, the present invention may be applied to engine oil, gear oil, and the like.

The flexural modulus of the molded component for an automobile of the present embodiment can be set to 2600 MPa or more, and the flexural modulus can be retained without a significant decrease even when brought into contact with automobile oil at a high temperature for a long time.

A method for imparting high-temperature oil resistance to a molded component for an automobile of the present invention includes setting the carboxyl end group concentration of the resin composition containing a polybutylene terephthalate resin to 20 mmol/kg or less. As described above, by setting the CEG concentration of the resin composition containing the PBT resin to 20 mmol/kg or less, the high-temperature oil resistance is improved. Therefore, in a molded component for an automobile produced by molding a resin composition containing a PBT resin, high-temperature oil resistance can be imparted by setting the CEG concentration of the resin composition to 20 mmol/kg or more. To set the CEG concentration to 20 mmol/kg or less, a predetermined amount of epoxy compound or carbodiimide compound may be added to the resin composition as described above.

Hereinafter, the present embodiment will be described in more detail with reference to examples and comparative examples, but the present embodiment is not limited to these examples.

### Examples 1 to 9 and Comparative Examples 1 to 4

In each Example or Comparative Example, a resin composition containing the components listed in Table 1 below was prepared. Using this resin composition, injection molding was carried out at a resin temperature of 260° C. and a mold temperature of 80° C. by a 50-ton horizontal molding machine manufactured by FUNAC Co., Ltd. to obtain a test piece having a length of 127 mm, a width of 12.7 mm, and a thickness of 1.6 mm was obtained. Using the obtained test piece, the following evaluation test was conducted.

TABLE 1

| | | | | | | | | | | | Compar- | Compar- | Compar- | Compar- |
|---|---|---|---|---|---|---|---|---|---|---|---|---|---|---|
| | | Ex- | Ex- | Ex- | Ex- | Ex- | Ex- | Ex- | Ex- | Ex- | ative | ative | ative | ative |
| | | ample | ample | ample | ample | ample | ample | ample | ample | ample | Example | Example | Example | Example |
| Items | | 1 | 2 | 3 | 4 | 5 | 6 | 7 | 8 | 9 | 1 | 2 | 3 | 4 |
| PBT resin 1 | (parts by mass | 100 | 100 | 100 | — | 100 | 100 | 100 | 100 | — | 100 | 100 | 100 | — |
| PBT resin 2 | (parts by mass) | — | — | — | 100 | — | — | — | — | 100 | — | — | — | 100 |
| Glass fiber | (parts by mass) | — | — | — | 18 | — | — | — | — | 18 | — | — | — | 18 |
| Epoxy type additive | (parts by mass) | 0.1 | 0.3 | 0.4 | 0.4 | — | — | — | — | — | — | 0.05 | — | — |
| Carbodiimide type | (Parts by mass) | — | — | — | — | 0.5 | 1 | 2 | 4 | 2 | — | — | 0.2 | — |
| additive | | | | | | | | | | | | | | |
| Flexural Modulus | (MPa) | 2620 | 2670 | 2750 | 4980 | 2600 | 2650 | 2650 | 2650 | 4880 | 2550 | 2580 | 2580 | 4840 |
| Oil resistance test | 100 hours | ◯ | ◯ | ◯ | ◯ | ◯ | ◯ | ◯ | ◯ | ◯ | ◯ | ◯ | ◯ | ◯ |
| | 300 hours | ◯ | ◯ | ◯ | ◯ | ◯ | ◯ | ◯ | ◯ | ◯ | X | X | X | X |
| | 500 hours | X | X | ◯ | ◯ | X | ◯ | ◯ | ◯ | ◯ | X | X | X | X |
| | 750 hours | X | X | X | ◯ | X | X | X | ◯ | ◯ | X | X | X | X |

| | | | | | | | | | | | | | |
|---|---|---|---|---|---|---|---|---|---|---|---|---|---|
| Carboxyl end group | 20 | 16 | 13 | 12 | 11 | 9 | 9 | 7 | 7 | 28 | 24 | 22 | 26 |
| concentration (mmol/g) | | | | | | | | | | | | | |
| Mold contamination | A | A | A | A | A | B | C | C | C | A | A | A | A |
| during molding | | | | | | | | | | | | | |

Details of each component described in Table 1 are as follows.

PBT resin 1: PBT non-reinforced material 1401-X06 manufactured by Toray Industries, Inc.

PBT resin 2: PBT SK602 manufactured by Du Pont
As a PBT-G15 material, 18 parts by mass of glass fiber is included with respect to 100 parts by mass of the PBT resin.

Epoxy type additive (epoxy compound): JONCRYL ADR4368 manufactured by BASF

Carbodiimide type additive (carbodiimide compound): Stabaxol P100 manufactured by Rhein Chemie

### <Evaluation>

1. Bending Test

For the test pieces obtained in respective Examples and Comparative Examples, bending test was permolded in a condition of a test speed of 10 mm/min and a distance between fulcrums: 40 mm by using Autograph AG-20KNI manufactured by Shimadzu Corporation as a testing machine. Table 1 shows numerical values of flexural modulus as representative of the measured values that were obtained.

2. Oil Resistance Test

Automatic transmission oil (ATF) AC Delco DEXRON-VI (Manufactured by Specialty Oil Company) was used as automobile oil. Then, the test pieces of respective Examples and Comparative Examples were immersed in the automobile oil and left in an environment at 150° C. for a predetermined time (respective times shown in Table 1). Thereafter, the test pieces were taken out, the oil was wiped off, and the “1. bending test” described above was carried out after leaving the test pieces standing for 24 hours. A case where the bending strength retention rate was 90% or more was evaluated as “O”, and a case where the flexural strength retention rate was less than 90% was evaluated as “X”. The evaluation results are shown in Table 1.

3. Measurement of Carboxyl End Group Concentration

The resin composition of each of Examples and Comparative Examples was heated and dissolved in cresol, and after cooling the solution, the solution was titrated with an alkaline solution (aqueous potassium hydroxide solution) to determine the acid value (COOH). This acid value was taken as the carboxyl end group concentration.

4. Evaluation of Mold Contamination During Molding <Mold Deposit Evaluation>

In order to evaluate mold contamination accompanied by molding of the resin composition of each of Examples and Comparative Example, examination was carried out acceleratively using a mold without a gas vent. The degree of mold contamination at 100 shot molding was visually confirmed and judged at the level of A to C as described below. The evaluation results are shown in Table 1.

A: Contamination was not observed.

B: Contamination was hardly observed.

C: Little contamination was observed, but the contamination was not problematic for practical use.

From Table 1, it can be seen that, by adding an epoxy type compound or a carbodiimide type compound, it is possible to adjust the CEG concentration serving as the decomposition starting point of the PBT resin, and it is understood that lowering the concentration improves the oil resistance. The oil resistance is improved when the epoxy compound is added in an amount of 0.1 part by mass or more (Examples 1 to 4) with respect to 100 parts by mass of the PBT resin, and when the carbodiimide compound is added in an amount of 0.5 parts by mass or more (Examples 5 to 9) with respect to 100 parts by mass of the PBT resin.

From Examples 4 and 9, it is understood that when the glass fiber is contained, the flexural modulus and the oil resistance are further improved.

From Examples 1 to 4, it can be seen that when the epoxy compound is used, no mold contamination occurs during molding, and the moldability is also excellent. Further, from Examples 5 and 6, it can be seen that when the carbodiimide compound is used in an amount of 0.5 to 1.0 part by mass, mold contamination is comparatively small and the moldability is excellent. In contrast, in Examples 7 to 9, mold contamination was observed when the carbodiimide compound exceeded 1 part by mass.

From each of Examples 1 to 4 and Examples 5 to 9, it can be seen that the CEG concentration is reduced and the flexural modulus is improved as the amount of added epoxy compound and carbodiimide compound increases.

In contrast, in Examples 1 to 9, the flexural modulus does not decrease as in the case of adding elastomer.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A high-temperature oil resistant molded component for an automobile, the high-temperature oil resistant molded component comprising a resin composition containing a polybutylene terephthalate resin and having a carboxyl end group concentration of 20 mmol/kg or less.

2. The high-temperature oil resistant molded component for an automobile according to claim 1, wherein the resin composition contains 0.1 to 0.5 parts by mass of an epoxy compound with respect to 100 parts by mass of the polybutylene terephthalate resin.

3. The high-temperature oil resistant molded component for an automobile according to claim 1, wherein the resin composition contains 0.5 to 5 parts by mass of a carbodiimide compound with respect to 100 parts by mass of the polybutylene terephthalate resin.

4. The high-temperature oil resistant molded component for an automobile according to claim 1, wherein the resin composition contains 0.5 to 1 part by mass of a carbodiimide compound with respect to 100 parts by mass of the polybutylene terephthalate resin.

5. The high-temperature oil resistant molded component for an automobile according to claim 1 having a flexural modulus of 2600 MPa or more.

6. The high-temperature oil resistant molded component for an automobile according to claim 1, which is a connector or a connector constituting member used for a part that comes into contact with automobile oil.

7. A method for imparting high-temperature oil resistance to a molded component for an automobile, the method comprising setting a carboxyl end group concentration of a resin composition containing a polybutylene terephthalate resin to 20 mmol/kg or less.
